(19) United States
(12) Patent Application Publication
(10) Pub. No.: US 2017/0139187 A1
(43) Pub. Date: May 18, 2017

(54) Lens Assembly

(71) Applicants: Sintai Optical (Shenzhen) Co., Ltd., ShenZhen City (CN); Asia Optical International Ltd., Tortola (GB)

(72) Inventors: Po-Yuan Shih, Taichung (TW); Hsi-Ling Chang, Taichung (TW); Chien-Hung Chen, Taichung (TW)

(21) Appl. No.: 15/420,170

(22) Filed: Jan. 31, 2017

Related U.S. Application Data
(63) Continuation-in-part of application No. 14/619,101, filed on Feb. 11, 2015.

(30) Foreign Application Priority Data
Feb. 26, 2014 (TW) 103106433
Apr. 8, 2014 (TW) 103112837

(51) Int. Cl. G02B 13/00; G02B 9/60

(52) U.S. Cl. CPC G02B 13/0045; G02B 9/60

(57) ABSTRACT

A lens assembly includes a first lens, a second lens, a third lens, a fourth lens and a fifth lens. The first lens is with positive refractive power. The second lens is with negative refractive power. The third lens is with positive refractive power. The fourth lens is a meniscus lens and includes a concave surface facing the object side and a convex surface facing the image side. The fifth lens includes a concave surface facing the image side. The first lens and the third lens are made of the same material. An Abbe number of the first lens, an Abbe number of the third lens and an Abbe number of the fifth lens are greater than an Abbe number of the second lens. The fourth lens satisfies: 0.66≦f₄/f≦0.7 wherein f is an effective focal length of the lens assembly and f₄ is an effective focal length of the fourth lens.

### CROSS REFERENCE TO RELATED APPLICATIONS

This application is a Continuation-In-Part of pending U.S. patent application Ser. No. 14/619,101, filed Feb. 11, 2015 and entitled “LENS ASSEMBLY,” which claimed the benefit of Taiwan patent application No. 103106433, filed Feb. 26, 2014 and Taiwan patent application No. 103112837, filed Apr. 8, 2014. The contents of these priority applications are incorporated herein by reference.

### BACKGROUND OF THE INVENTION

Field of the Invention

The invention relates to a lens assembly.

Description of the Related Art

Digital still cameras and mobile phones have been gradually developed toward high pixel number and miniaturization. Therefore, the requirements for lens assemblies with miniaturization and high resolution are greatly increased. The well-known lens assembly with five lenses usually uses one lens with low Abbe number and four lenses with high Abbe number in order to meet the requirements of miniaturization and high resolution. But, it is not perfect and still needs improvement. Therefore, a lens assembly needs a new structure in order to meet the requirement of the present.

### BRIEF SUMMARY OF THE INVENTION

The invention provides a lens assembly to solve the above problems. The lens assembly of the invention, provided with characteristics of a shortened total lens length, still has a good optical performance and can meet a requirement of resolution.

The lens assembly in accordance with an exemplary embodiment of the invention includes a first lens, a second lens, a third lens, a fourth lens and a fifth lens, all of which are arranged in sequence from an object side to an image side along an optical axis. The first lens is with positive refractive power. The second lens is with negative refractive power. The third lens is with positive refractive power. The fourth lens is a meniscus lens and includes a concave surface facing the object side and a convex surface facing the image side. The fifth lens includes a concave surface facing the image side. The first lens and the third lens are made of the same material and an Abbe number of the first lens is the same as an Abbe number of the third lens. An Abbe number of the first lens, an Abbe number of the third lens and an Abbe number of the fifth lens are greater than an Abbe number of the second lens. The fourth lens satisfies: 0.66≦f₄/f≦0.7 wherein f is an effective focal length of the lens assembly and f₄ is an effective focal length of the fourth lens.

In another exemplary embodiment, an Abbe number of the first lens, an Abbe number of the third lens and an Abbe number of the fifth lens are greater than an Abbe number of the second lens and an Abbe number of the fourth lens.

In yet another exemplary embodiment, the first lens, the second lens, the third lens, the fourth lens and the fifth lens are made of plastic material.

In another exemplary embodiment, the lens assembly further includes a stop disposed between the object side and the second lens.

In yet another exemplary embodiment, the first lens includes two surfaces, at least one of which is an aspheric surface or both of which are aspheric surfaces; the second lens includes two surfaces, at least one of which is an aspheric surface or both of which are aspheric surfaces; the third lens includes two surfaces, at least one of which is an aspheric surface or both of which are aspheric surfaces; the fourth lens includes two surfaces, at least one of which is an aspheric surface or both of which are aspheric surfaces; and the fifth lens further includes a surface, wherein the surface is an aspheric surface, or the concave surface of the fifth lens is an aspheric surface, or both of the surface and the concave surface of the fifth lens are aspheric surfaces.

In another exemplary embodiment, the first lens and the second lens satisfy −2.5≦(R₁₁−R₁₂)/(R₁₁+R₁₂)≦−1.9, 0.4≦(R₂₁−R₂₂)/(R₂₁+R₂₂)≦0.5 wherein R₁₁ is a radius of curvature of an object side surface of the first lens, R₁₂ is a radius of curvature of an image side surface of the first lens, R₂₁ is a radius of curvature of an object side surface of the second lens and R₂₂ is a radius of curvature of an image side surface of the second lens.

In yet another exemplary embodiment, the second lens and the third lens satisfy 0.4≦(R₂₁−R₂₂)/(R₂₁+R₂₂)≦0.5, −14.0≦(R₃₁−R₃₂)/(R₃₁+R₃₂)≦−2.4 wherein R₂₁ is a radius of curvature of an object side surface of the second lens, R₂₂ is a radius of curvature of an image side surface of the second lens, R₃₁ is a radius of curvature of an object side surface of the third lens and R₃₂ is a radius of curvature of an image side surface of the third lens.

In another exemplary embodiment, the first lens and the third lens satisfy −2.5≦(R₁₁−R₁₂)/(R₁₁+R₁₂)≦−1.9, −14.0≦(R₃₁−R₃₂)/(R₃₁+R₃₂)≦−2.4 wherein R₁₁ is a radius of curvature of an object side surface of the first lens, R₁₂ is a radius of curvature of an image side surface of the first lens, R₃₁ is a radius of curvature of an object side surface of the third lens and R₃₂ is a radius of curvature of an image side surface of the third lens.

In yet another exemplary embodiment, the second lens and the third lens satisfy −1.2≦f₂/f≦−1.0, 2.2≦f₃/f≦2.7 wherein f₂ is an effective focal length of the second lens, f is an effective focal length of the lens assembly and f₃ is an effective focal length of the third lens.

In another exemplary embodiment, the lens assembly satisfies 0.73≦f/TTL≦0.80 wherein f is an effective focal length of the lens assembly and TTL is a distance from an object side surface of the first lens to an image plane along the optical axis.

In yet another exemplary embodiment, the first lens is a biconvex lens and includes a convex surface facing the object side and a convex surface facing the image side; the second lens is a meniscus lens and includes a convex surface facing the object side and a concave surface facing the image side; the third lens is a biconvex lens and includes a convex surface facing the object side and a convex surface facing the image side; the fourth lens is a meniscus lens with positive refractive power and includes a concave surface facing the object side and a convex surface facing the image side; and the fifth lens is with negative refractive power.

In another exemplary embodiment, the first lens satisfies −2.5≦(R₁₁−R₁₂)/(R₁₁+R₁₂)≦−1.9 wherein R₁₁ is a radius of curvature of the convex surface of the object side of the first lens and R₁₂ is a radius of curvature of the convex surface of the image side of the first lens.

In yet another exemplary embodiment, the second lens satisfies 0.4≦(R₂₁−R₂₂)/(R₁₁+R₂₂)≦0.5 wherein R₂₁ is a radius of curvature of the convex surface of the object side of the second lens and R₂₂ is a radius of curvature of the concave surface of the image side of the second lens.

In another exemplary embodiment, the second lens satisfies −1.2≦f₂/f≦−1.0 wherein f₂ is an effective focal length of the second lens and f is an effective focal length of the lens assembly.

In yet another exemplary embodiment, the third lens satisfies −14.0≦(R₃₁−R₃₂)/(R₃₁+R₃₂)≦−2.4 wherein R₃₁ is a radius of curvature of the convex surface of the object side of the third lens and R₃₂ is a radius of curvature of the convex surface of the image side of the third lens.

In another exemplary embodiment, the third lens satisfies 2.2≦f₃/f≦2.7 wherein f₃ is an effective focal length of the third lens and f is an effective focal length of the lens assembly.

In yet another exemplary embodiment, the first lens, the third lens and the fourth lens are made of glass material, and the second lens and the fifth lens are made of plastic material.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIG. 2A depicts a longitudinal spherical aberration of the lens assembly in accordance with the first embodiment of the invention;

FIG. 2B is an astigmatic field curves diagram of the lens assembly in accordance with the first embodiment of the invention;

FIG. 2C is a distortion diagram of the lens assembly in accordance with the first embodiment of the invention;

FIG. 3 is a lens layout and optical path diagram of a lens assembly in accordance with a second embodiment of the invention;

FIG. 4A depicts a longitudinal spherical aberration of the lens assembly in accordance with the second embodiment of the invention;

FIG. 4B is an astigmatic field curves diagram of the lens assembly in accordance with the second embodiment of the invention;

FIG. 4C is a distortion diagram of the lens assembly in accordance with the second embodiment of the invention;

FIG. 5 is a lens layout and optical path diagram of a lens assembly in accordance with a third embodiment of the invention;

FIG. 6A depicts a longitudinal spherical aberration of the lens assembly in accordance with the third embodiment of the invention;

FIG. 6B is an astigmatic field curves diagram of the lens assembly in accordance with the third embodiment of the invention; and

FIG. 6C is a distortion diagram of the lens assembly in accordance with the third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

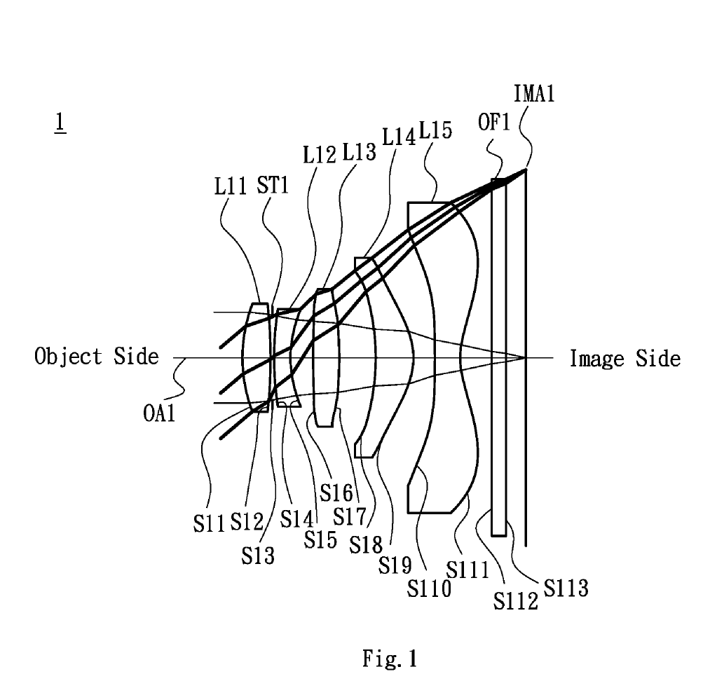

Referring to FIG. 1, FIG. 1 is a lens layout and optical path diagram of a lens assembly in accordance with a first embodiment of the invention. The lens assembly 1 includes a first lens L11, a stop ST1, a second lens L12, a third lens L13, a fourth lens L14, a fifth lens L15 and an Optical filter OF1, all of which are arranged in sequence from an object side to an image side along an optical axis OA1. In operation, an image of light rays from the object side is formed at an image plane IMA1. The first lens L11 is made of glass material and with positive refractive power, wherein the object side surface S11 is a convex surface, the image side surface S12 is a convex surface and both of the object side surface S11 and image side surface S12 are aspheric surfaces. The second lens L12 is made of plastic material and with negative refractive power, wherein the object side surface S14 is a convex surface, the image side surface S15 is a concave surface and both of the object side surface S14 and image side surface S15 are aspheric surfaces. The third lens L13 is made of glass material and with positive refractive power, wherein the object side surface S16 is a convex surface, the image side surface S17 is a convex surface and both of the object side surface S16 and image side surface S17 are aspheric surfaces. The fourth lens L14 is made of glass material and with positive refractive power, wherein the object side surface S18 is a concave surface, the image side surface S19 is a convex surface and both of the object side surface S18 and image side surface S19 are aspheric surfaces. The fifth lens L15 is made of plastic material and with negative refractive power, wherein around the optical axis OA1 of the object side surface S110 is a concave surface, around the optical axis OA1 of the image side surface S111 is a concave surface and both of the object side surface S110 and image side surface 5111 are aspheric surfaces. Both of the object side surface S112 and image side surface S113 of the optical filter OF1 are plane surfaces. The first lens L11 and the third lens L13 are made of the same material and with the same Abbe number. The Abbe number of the first lens L11, the third lens L13 and the fifth lens L15 are greater than the Abbe number of the second lens L12.

In order to maintain excellent optical performance of the lens assembly in accordance with the first embodiment of the invention, the lens assembly 1 must satisfies the following seven conditions:

0.73≦f1/TTL1≦0.80 (1)

−2.5≦(R1₁₁−R1₁₂)/(R1₁₁+R1₁₂)≦−1.9 (2)

0.4≦(R1₂₁−R1₂₂)/(R1₂₁+R1₂₂)≦0.5 (3)

−1.2≦f1₂/f1≦−1.0 (4)

−14.0≦(R1₃₁−R1₃₂)/(R1₃₁+R1₃₂)≦2.4 (5)

2.2≦f1₃/f1≦2.7 (6)

0.66≦f1₄/f1≦0.70 (7)

wherein f1 is an effective focal length of the lens assembly 1, TTL1 is a distance from the object side surface S11 of the first lens L11 to the image plane IMA1 along the optical axis OA1, R1₁₁ is a radius of curvature of the object side surface S11 of the first lens L11, R1₁₂ is a radius of curvature of the image side surface S12 of the first lens L11, R1₂₁ is a radius of curvature of the object side surface S14 of the second lens L12, R1₂₂ is a radius of curvature of the image side surface S15 of the second lens L12, f1₂ is an effective focal length of the second lens L12, R1₃₁ is a radius of curvature of the object side surface S16 of the third lens L13, R1₃₂ is a radius of curvature of the image side surface S17 of the third lens L13, f1₃ is an effective focal length of the third lens L13, and f1₄ is an effective focal length of the fourth lens L14.

By the above design of the lenses and stop ST1, the lens assembly 1 is provided with a shortened total lens length, an effective corrected aberration and an increased resolution.

In order to achieve the above purposes and effectively enhance the optical performance, the lens assembly 1 in accordance with the first embodiment of the invention is provided with the optical specifications shown in Table 1, which include the effective focal length, F-number, field of view, total lens length, radius of curvature of each lens surface, thickness between adjacent surface, refractive index of each lens and Abbe number of each lens. Table 1 shows that the effective focal length is equal to 2.667 mm, F-number is equal to 2.4, field of view is equal to 80.20° and total lens length is equal to 3.500 mm for the lens assembly 1 of the first embodiment of the invention.

TABLE 1
Effective Focal Length = 2.667 mm F-number = 2.4
Field of View = 80.20° Total Lens Length = 3.500 mm

| | Radius of | | | | |
|---|---|---|---|---|---|
| Surface | Curvature | Thickness | | | |
| Number | (mm) | (mm) | Nd | Vd | Remark |
| S11 | 1.67161 | 0.350 | 1.544 | 56.1 | The First Lens L11 |
| S12 | −4.18918 | 0.020 | | | |
| S13 | ∞ | 0.022 | | | Stop ST1 |
| S14 | 2.99021 | 0.200 | 1.636 | 23.9 | The Second Lens L12 |
| S15 | 1.14049 | 0.281 | | | |
| S16 | 6.14331 | 0.324 | 1.544 | 56.1 | The Third Lens L13 |
| S17 | −7.09446 | 0.452 | | | |
| S18 | −2.93867 | 0.463 | 1.544 | 56.1 | The Fourth Lens L14 |
| S19 | −0.78418 | 0.267 | | | |
| S110 | −25.32207 | 0.311 | 1.582 | 30.2 | The Fifth Lens L15 |
| S111 | 0.89747 | 0.389 | | | |
| S112 | ∞ | 0.175 | 1.517 | 64.2 | Optical Filter OF1 |
| S113 | ∞ | 0.247 | | | |

The aspheric surface sag z of each lens in table 1 can be calculated by the following formula:

z=ch²/{1+[1−(k+1)c²h²]^{1/2}}+Ah⁴+Bh⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F and G are aspheric coefficients.

In the first embodiment, the conic constant k and the aspheric coefficients A, B, C, D, E, F, G of each surface are shown in Table 2.

TABLE 2

| Surface | | | | | | | | |
|---|---|---|---|---|---|---|---|---|
| Number | k | A | B | C | D | E | F | G |
| S11 | −4.47386E−01 | −1.81007E−02 | −8.75315E−02 | 2.09152E−01 | −2.67436E−02 | −1.04099E+00 | 6.56942E−01 | 4.06723E−01 |
| S12 | −1.29378E+01 | 1.15721E−01 | 4.98721E−02 | −5.78101E−01 | 3.27185E−01 | 0.00000E+00 | 0.00000E+00 | 0.00000E+00 |
| S14 | −7.33678E+01 | 2.59760E−02 | 6.12836E−01 | −2.17969E+00 | 2.05772E+00 | −2.67839E−01 | 0.00000E+00 | 0.00000E+00 |
| S15 | −7.12174E+00 | 3.52610E−02 | 5.09954E−01 | −1.28842E+00 | 5.34086E−01 | 1.52614E+00 | −2.08532E+00 | 7.23775E−01 |
| S16 | −6.38542E+01 | −1.49299E−01 | 1.37209E−01 | −5.92824E−02 | 2.37729E−01 | 5.34039E−01 | −5.09840E−01 | −8.11985E−02 |
| S17 | 2.34986E+01 | −1.34187E−01 | 7.55583E−03 | −1.69081E−01 | 2.02289E−01 | 3.95223E−01 | −4.82523E−01 | 5.57866E−01 |
| S18 | 0.00000E+00 | −4.12691E−03 | −1.07456E−02 | 6.72570E−02 | −1.46952E−01 | −4.32319E−03 | 6.85119E−02 | −1.24249E−02 |
| S19 | −3.83778E+00 | −1.69448E−01 | 2.88583E−01 | −1.55290E−01 | 4.62430E−03 | 2.19213E−02 | −1.71177E−03 | −2.93449E−03 |
| S110 | 7.36028E+01 | −1.28266E−01 | 3.70620E−02 | 2.07132E−03 | −1.44238E−03 | −3.11310E−05 | 5.57874E−05 | −1.94870E−05 |
| S111 | −6.80767E+00 | −1.16831E−01 | 5.03710E−02 | −1.73617E−02 | 2.65320E−03 | −1.40744E−04 | −2.14154E−06 | 1.17604E−06 |

For the lens assembly 1 of the first embodiment, the Abbe number of the first lens L11 and the third lens L13 are equal to 56.1, the Abbe number of the fifth lens L15 is equal to 30.2, the Abbe number of the second lens L12 is equal to 23.9, the effective focal length f1 of the lens assembly 1 is equal to 2.667 mm, the distance TTL1 from the object side surface S11 of the first lens L11 to the image plane IMA1 along the optical axis OA1 is equal to 3.500 mm, the radius of curvature R1₁₁ of the object side surface S11 of the first lens L11 is equal to 1.67161 mm, the radius of curvature R1₁₂ of the image side surface S12 of the first lens L11 is equal to −4.18918 mm, the radius of curvature R1₂₁ of the object side surface S14 of the second lens L12 is equal to 2.99021 mm, the radius of curvature R1₂₂ of the image side surface S15 of the second lens L12 is equal to 1.14049 mm, the effective focal length f1₂ of the second lens L12 is equal to 3.00666 mm, the radius of curvature R1₃₁ of the object side surface S16 of the third lens L13 is equal to 6.14331 mm, the radius of curvature R1₃₂ of the image side surface S17 of the third lens L13 is equal to 7.09446 mm, the effective focal length f1₃ of the third lens L13 is equal to 6.08317 mm, and the effective focal length fl₄ of the fourth lens L14 is equal to 1.82098 mm. According to the above data, the following values can be obtained:

f1/TTL1=0.7619,

(R1₁₁−R1₁₂)/(R1₁₁+R1₁₂)=−2.3279,

(R1₂₁−R1₂₂)/(R1₂₁+R1₂₂)=0.4478,

f1₂/f1=−1.1275,

(R1₃₁−R1₃₂)/(R1₃₁+R1₃₂)=−13. 9177,

f1₃/f1=2.2811,

f1₄/f1=0. 6828
which respectively satisfy the above conditions (1)-(7).

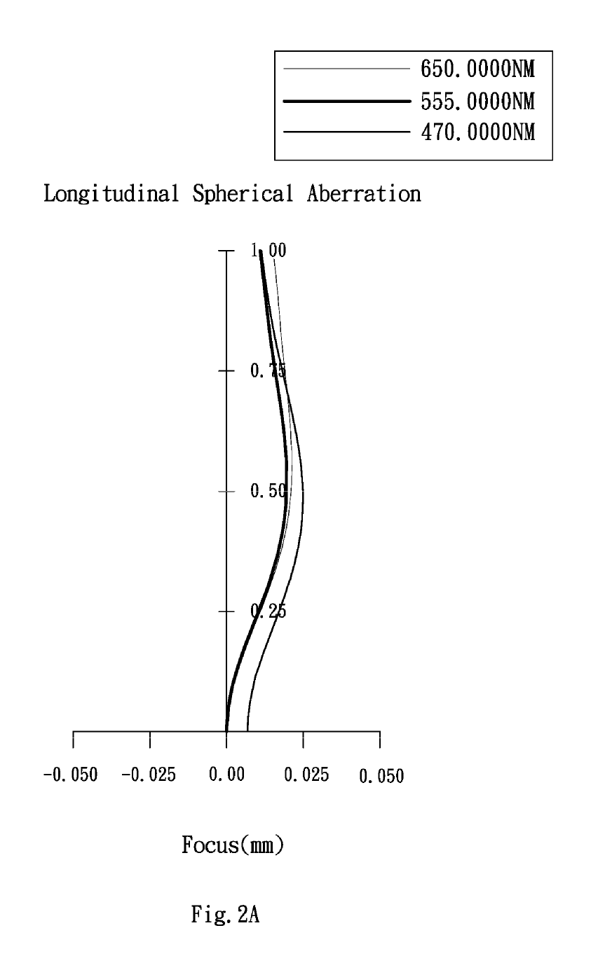

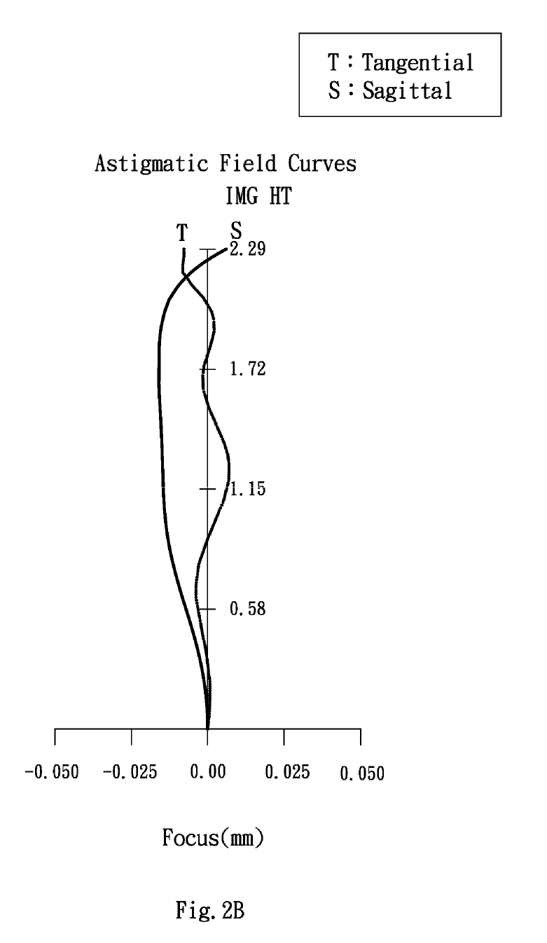

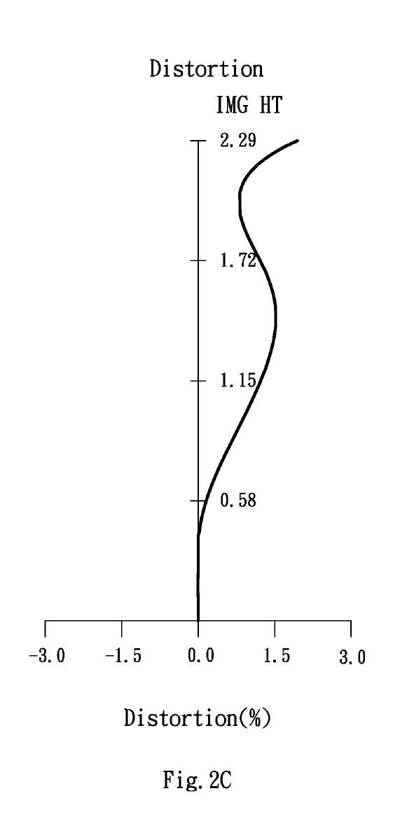

By the above arrangements of the lenses and stop ST1, the lens assembly 1 of the first embodiment can meet the requirements of optical performance as seen in FIGS. 2A-2C, wherein FIG. 2A shows a longitudinal spherical aberration diagram of the lens assembly 1 in accordance with the first embodiment of the invention, FIG. 2B shows an astigmatic field curves of the lens assembly 1 in accordance with the first embodiment of the invention and FIG. 2C shows a distortion diagram of the lens assembly 1 in accordance with the first embodiment of the invention.

It can be seen from FIG. 2A that the longitudinal spherical aberration in the lens assembly 1 of the first embodiment ranges between 0.000 mm and 0.025 mm for the wavelength of 470.0000 nm, 555.0000 nm and 650.0000 nm. It can be seen from FIG. 2B that the astigmatic field curves of tangential direction and sagittal direction in the lens assembly 1 of the first embodiment ranges between 0.025 mm and 0.0125 mm for the wavelength of 555.0000 nm. It can be seen from FIG. 2C that the distortion in the lens assembly 1 of the first embodiment ranges between 0% and 2.0% for the wavelength of 555.0000 nm. It is obvious that the longitudinal spherical aberration, the astigmatic field curves and the distortion of the lens assembly 1 of the first embodiment can be corrected effectively. Therefore, the lens assembly 1 of the first embodiment is capable of good optical performance.

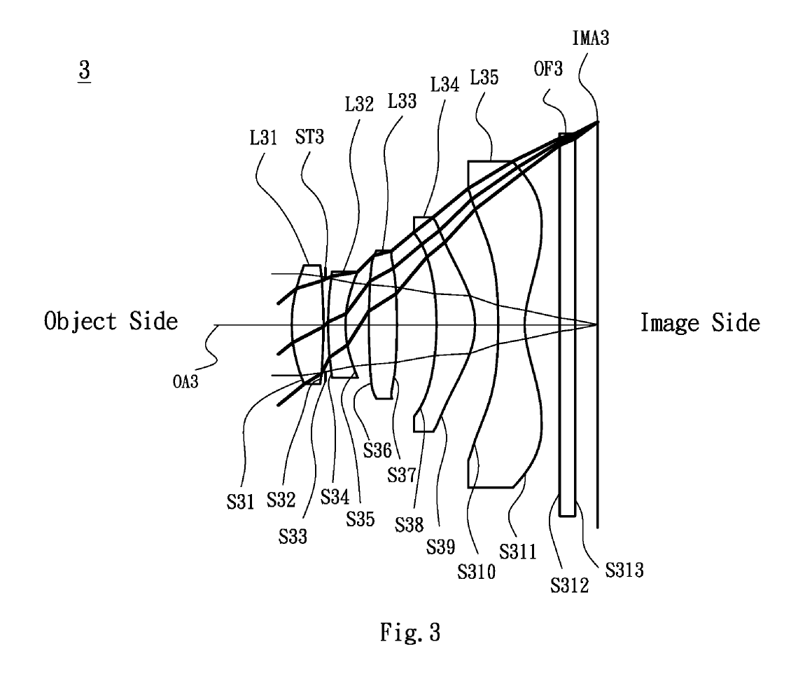

Referring to FIG. 3, FIG. 3 is a lens layout and optical path diagram of a lens assembly in accordance with a second embodiment of the invention. The lens assembly 3 includes a first lens L31, a stop ST3, a second lens L32, a third lens L33, a fourth lens L34, a fifth lens L35 and an Optical filter OF3, all of which are arranged in sequence from an object side to an image side along an optical axis OA3. In operation, an image of light rays from the object side is formed at an image plane IMA3. The first lens L31 is made of glass material and with positive refractive power, wherein the object side surface S31 is a convex surface, the image side surface S32 is a convex surface and both of the object side surface S31 and image side surface S32 are aspheric surfaces. The second lens L32 is made of plastic material and with negative refractive power, wherein the object side surface S34 is a convex surface, the image side surface S35 is a concave surface and both of the object side surface S34 and image side surface S35 are aspheric surfaces. The third lens L33 is made of glass material and with positive refractive power, wherein the object side surface S36 is a convex surface, the image side surface S37 is a convex surface and both of the object side surface S36 and image side surface S37 are aspheric surfaces. The fourth lens L34 is made of glass material and with positive refractive power, wherein the object side surface S38 is a concave surface, the image side surface S39 is a convex surface and both of the object side surface S38 and image side surface S39 are aspheric surfaces. The fifth lens L35 is made of plastic material and with negative refractive power, wherein around the optical axis OA3 of the object side surface S310 is a concave surface, around the optical axis OA3 of the image side surface S311 is a concave surface and both of the object side surface S310 and image side surface S311 are aspheric surfaces. Both of the object side surface S312 and image side surface S313 of the optical filter OF3 are plane surfaces. The first lens L31 and the third lens L33 are made of the same material and with the same Abbe number. The Abbe number of the first lens L31, the third lens L33 and the fifth lens L35 are greater than the Abbe number of the second lens L32.

In order to maintain excellent optical performance of the lens assembly in accordance with the second embodiment of the invention, the lens assembly 3 must satisfies the following seven conditions:

0.73≦f3/TTL3≦0.80 (8)

−2.5≦(R3₁₁−R3₁₂)/(R3₁₁+R3₁₂)≦−1.9 (9)

0.4≦(R3₂₁−R3₂₂)/(R3₂₁+R3₂₂)≦0.5 (10)

−1.2≦f3₂/f3≦−1.0 (11)

−14.0≦(R3₃₁−R3₃₂)/(R3₃₁+R3₃₂)≦−2.4 (12)

2.2≦f3₃/f3≦2.7 (13)

0.65≦f3₄/f3≦0.7 (14)

wherein f3 is an effective focal length of the lens assembly 3, TTL3 is a distance from the object side surface S31 of the first lens L31 to the image plane IMA3 along the optical axis OA3, R3₁₁ is a radius of curvature of the object side surface S31 of the first lens L31, R3₁₂ is a radius of curvature of the image side surface S32 of the first lens L31, R3₂₁ is a radius of curvature of the object side surface S34 of the second lens L32, R3₂₂ is a radius of curvature of the image side surface S35 of the second lens L32, f3₂ is an effective focal length of the second lens L32, R3₃₁ is a radius of curvature of the object side surface S36 of the third lens L33, R3₃₂ is a radius of curvature of the image side surface S37 of the third lens L33, f3₃ is an effective focal length of the third lens L33, and f3₄ is an effective focal length of the fourth lens L34.

By the above design of the lenses and stop ST3, the lens assembly 3 is provided with a shortened total lens length, an effective corrected aberration and an increased resolution.

In order to achieve the above purposes and effectively enhance the optical performance, the lens assembly 3 in accordance with the second embodiment of the invention is provided with the optical specifications shown in Table 3, which include the effective focal length, F-number, field of view, total lens length, radius of curvature of each lens surface, thickness between adjacent surface, refractive index of each lens and Abbe number of each lens. Table 3 shows that the effective focal length is equal to 2.773 mm, F-number is equal to 2.4, field of view is equal to 77.9° and total lens length is equal to 3.500 mm for the lens assembly 3 of the second embodiment of the invention.

TABLE 3
Effective Focal Length = 2.773 mm F-number = 2.4
Field of View = 77.90° Total Lens Length = 3.500 mm

| | Radius of | | | | |
|---|---|---|---|---|---|
| Surface | Curvature | Thickness | | | |
| Number | (mm) | (mm) | Nd | Vd | Remark |
| S31 | 1.54820 | 0.365 | 1.544 | 56.1 | The First Lens L31 |
| S32 | −4.76373 | 0.020 | | | |
| S33 | ∞ | 0.030 | | | Stop ST3 |
| S34 | 3.13608 | 0.200 | 1.636 | 23.9 | The Second Lens L32 |
| S35 | 1.13344 | 0.265 | | | |
| S36 | 4.79957 | 0.322 | 1.544 | 56.1 | The Third Lens L33 |
| S37 | −11.41386 | 0.455 | | | |
| S38 | −2.95380 | 0.440 | 1.544 | 56.1 | The Fourth Lens L34 |
| S39 | −0.80249 | 0.263 | | | |
| S310 | −7.67356 | 0.302 | 1.544 | 56.1 | The Fifth Lens L35 |
| S311 | 0.92807 | 0.402 | | | |
| S312 | ∞ | 0.175 | 1.517 | 64.2 | Optical Filter OF3 |
| S313 | ∞ | 0.247 | | | |

The aspheric surface sag z of each lens in table 3 can be calculated by the following formula:

z=ch²/{1+[1−(k+1)c²h²]^{1/2}}+Ah⁴+Bh⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F and G are aspheric coefficients.

In the second embodiment, the conic constant k and the aspheric coefficients A, B, C, D, E, F, G of each surface are shown in Table 4.

TABLE 4

| Surface | | | | | | | | |
|---|---|---|---|---|---|---|---|---|
| Number | k | A | B | C | D | E | F | G |
| S31 | −4.72266E−01 | −1.83261E−02 | −8.73144E−02 | 2.07263E−01 | −7.32316E−02 | −1.04099E+00 | 6.56942E−01 | 4.06723E−01 |
| S32 | −5.44952E+00 | 1.07940E−01 | 5.40900E−02 | −5.83754E−01 | 3.35640E−01 | 0.00000E+00 | 0.00000E+00 | 0.00000E+00 |
| S34 | −7.69794E+01 | 2.37800E−02 | 6.19147E−01 | −2.12998E+00 | 2.11097E+00 | −2.67839E−01 | 0.00000E+00 | 0.00000E+00 |
| S35 | −6.48306E+00 | 4.89782E−02 | 5.36426E−01 | −1.25994E+00 | 5.19101E−01 | 1.52614E+00 | −2.08532E+00 | 7.23775E−01 |
| S36 | −2.18130E+01 | −1.36236E−01 | 1.40198E−01 | −5.74019E−02 | 2.32518E−01 | 5.21208E−01 | −5.09840E−01 | −8.11985E−02 |
| S37 | −2.11970E+00 | −1.30560E−01 | 1.27812E−02 | −1.65892E−01 | 1.98974E−01 | 3.93661E−01 | −4.73430E−01 | 5.57866E−01 |
| S38 | 0.00000E+00 | −5.06452E−03 | −1.93551E−02 | 6.06798E−02 | −1.44361E−01 | −1.45152E−03 | 6.94533E−02 | −1.15955E−02 |
| S39 | −4.10594E+00 | −1.75383E−01 | 2.96061E−01 | −1.52665E−01 | 4.92625E−03 | 2.16895E−02 | −2.06232E−03 | −3.23406E−03 |
| S310 | 0.00000E+00 | −1.17324E−01 | 3.90764E−02 | 2.29827E−03 | −1.46364E−03 | −4.69290E−05 | 5.02088E−05 | −1.97339E−05 |
| S311 | −7.69069E+00 | −1.14763E−01 | 4.94443E−02 | −1.78088E−02 | 2.64939E−03 | −1.35550E−04 | 8.69419E−07 | 2.83335E−06 |

For the lens assembly 3 of the second embodiment, the Abbe number of the first lens L31 and the third lens L33 are equal to 56.1, the Abbe number of the fifth lens L35 is equal to 56.1, the Abbe number of the second lens L32 is equal to 23.9, the effective focal length f3 of the lens assembly 3 is equal to 2.773 mm, the distance TTL3 from the object side surface S31 of the first lens L31 to the image plane IMA3 along the optical axis OA3 is equal to 3.500 mm, the radius of curvature R3₁₁ of the object side surface S31 of the first lens L31 is equal to 1.54820 mm, the radius of curvature R3₁₂ of the image side surface S32 of the first lens L31 is equal to 4.76373 mm, the radius of curvature R3₂₁ of the object side surface S34 of the second lens L32 is equal to 3.13608 mm, the radius of curvature R3₂₂ of the image side surface S35 of the second lens L32 is equal to 1.13344 mm, the effective focal length f3₂ of the second lens L32 is equal to 2.88481 mm, the radius of curvature R3₃₁ of the object side surface S36 of the third lens L33 is equal to 4.79957 mm, the radius of curvature R3₃₂ of the image side surface S37 of the third lens L33 is equal to −11.41386 mm, the effective focal length f3₃ of the third lens L33 is equal to 6.23269 mm, and the effective focal length f3₄ of the fourth lens L34 is equal to 1.88222 mm. According to the above data, the following values can be obtained:

f3/TTL3=0.7924,

(R3₁₁−R3₁₂)/(R3₁₁+R3₁₂)=−1.9629,

(R3₂₁−R3₂₂)/(R3₂₁+R3₂₂)=0.4691,

f3₂/f3=−1.0401,

(R3₃₁−R3₃₂)/(R3₃₁+R3₃₂)=−2.4513,

f3₃/f3=2.2473,

f3₄/f3=0.6786
which respectively satisfy the above conditions (8)-(14).

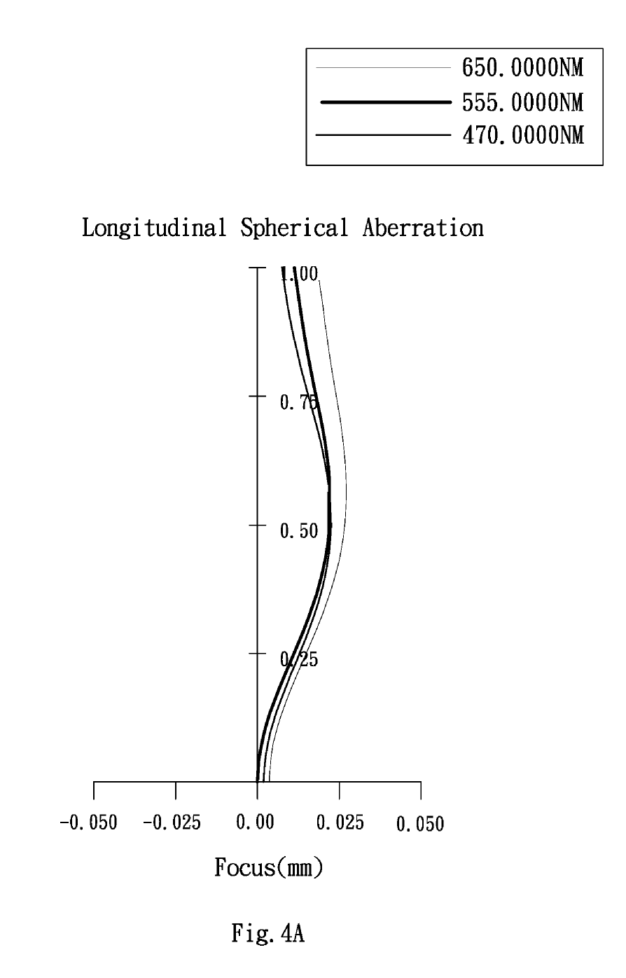

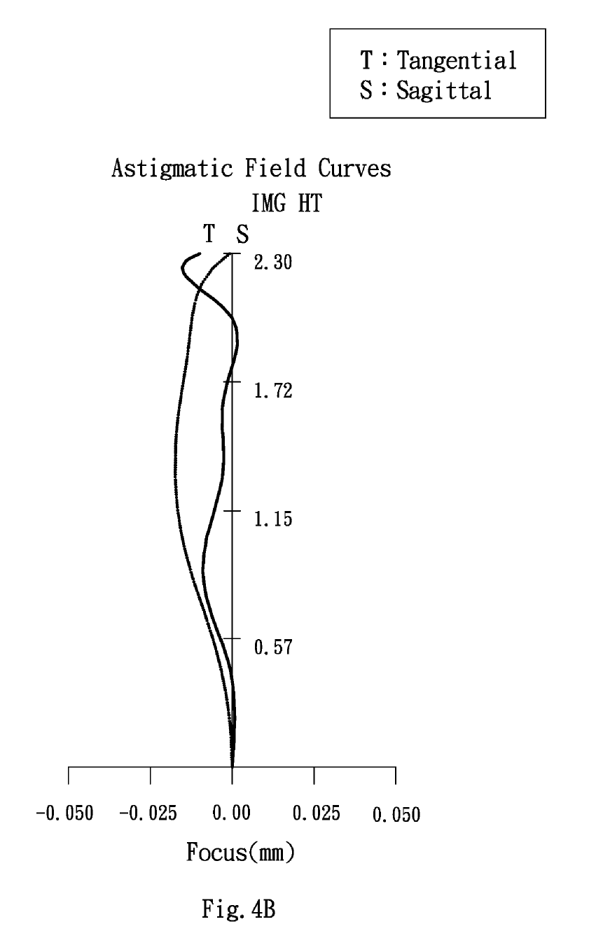

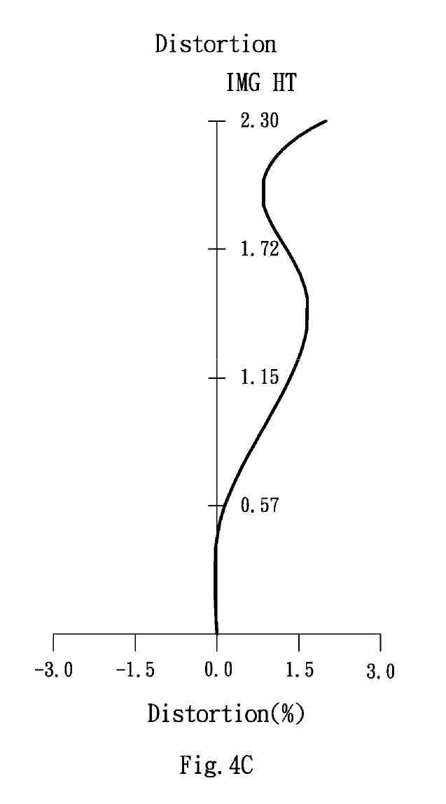

By the above arrangements of the lenses and stop ST3, the lens assembly 3 of the second embodiment can meet the requirements of optical performance as seen in FIGS. 4A-4C, wherein FIG. 4A shows a longitudinal spherical aberration diagram of the lens assembly 3 in accordance with the second embodiment of the invention, FIG. 4B shows an astigmatic field curves of the lens assembly 3 in accordance with the second embodiment of the invention and FIG. 4C shows a distortion diagram of the lens assembly 3 in accordance with the second embodiment of the invention.

It can be seen from FIG. 4A that the longitudinal spherical aberration in the lens assembly 3 of the second embodiment ranges between 0.000 mm and 0.03 mm for the wavelength of 470.0000 nm, 555.0000 nm and 650.0000 nm. It can be seen from FIG. 4B that the astigmatic field curves of tangential direction and sagittal direction in the lens assembly 3 of the second embodiment ranges between 0.025 mm and 0.005 mm for the wavelength of 555.0000 nm. It can be seen from FIG. 4C that the distortion in the lens assembly 3 of the second embodiment ranges between 0% and 2.0% for the wavelength of 555.0000 nm. It is obvious that the longitudinal spherical aberration, the astigmatic field curves and the distortion of the lens assembly 3 of the second embodiment can be corrected effectively. Therefore, the lens assembly 3 of the second embodiment is capable of good optical performance.

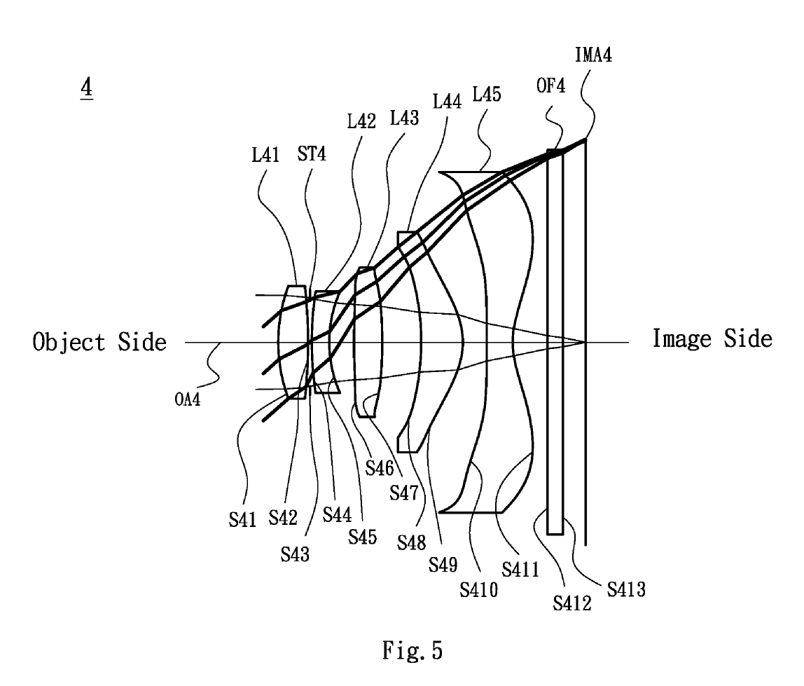

Referring to FIG. 5, FIG. 5 is a lens layout and optical path diagram of a lens assembly in accordance with a third embodiment of the invention. The lens assembly 4 includes a first lens L41, a stop ST4, a second lens L42, a third lens L43, a fourth lens L44, a fifth lens L45 and an Optical filter OF4, all of which are arranged in sequence from an object side to an image side along an optical axis OA4. In operation, an image of light rays from the object side is formed at an image plane IMA4. The first lens L41 is made of glass material and with positive refractive power, wherein the object side surface S41 is a convex surface, the image side surface S42 is a convex surface and both of the object side surface S41 and image side surface S42 are aspheric surfaces. The second lens L42 is made of plastic material and with negative refractive power, wherein the object side surface S44 is a convex surface, the image side surface S45 is a concave surface and both of the object side surface S44 and image side surface S45 are aspheric surfaces. The third lens L43 is made of glass material and with positive refractive power, wherein the object side surface S46 is a convex surface, the image side surface S47 is a convex surface and both of the object side surface S46 and image side surface S47 are aspheric surfaces. The fourth lens L44 is made of glass material and with positive refractive power, wherein the object side surface S48 is a concave surface, the image side surface S49 is a convex surface and both of the object side surface S48 and image side surface S49 are aspheric surfaces. The fifth lens L45 is made of plastic material and with negative refractive power, wherein around the optical axis OA4 of the object side surface S410 is a convex surface, around the optical axis OA4 of the image side surface S411 is a concave surface and both of the object side surface S410 and image side surface S411 are aspheric surfaces. Both of the object side surface S412 and image side surface S413 of the optical filter OF4 are plane surfaces. The first lens L41 and the third lens L43 are made of the same material and with the same Abbe number. The Abbe number of the first lens L41, the third lens L43 and the fifth lens L45 are greater than the Abbe number of the second lens L42.

In order to maintain excellent optical performance of the lens assembly in accordance with the third embodiment of the invention, the lens assembly 4 must satisfies the following seven conditions:

0.73≦f4/TTL4≦0.80 (15)

−2.5≦(R4₁₁−R4₁₂)/(R4₁₁+R4₁₂)≦−1.9 (16)

0.4≦(R4₂₁−R4₂₂)/(R4₂₁+R4₂₂)≦0.5 (17)

−1.2≦f4₂/f4≦−1.0 (18)

−14.0≦(R4₃₁−R4₃₂)/(R4₃₁ +R4₃₂)≦−2.4 (19)

2.2≦f4₃/f4≦2.7 (20)

0.65≦f4₄/f4≦0.7 (21)

wherein f4 is an effective focal length of the lens assembly 4, TTL4 is a distance from the object side surface S41 of the first lens L41 to the image plane IMA4 along the optical axis OA4, R4₁₁ is a radius of curvature of the object side surface S41 of the first lens L41, R4₁₂ is a radius of curvature of the image side surface S42 of the first lens L41, R4₂₁ is a radius of curvature of the object side surface S44 of the second lens L42, R4₂₂ is a radius of curvature of the image side surface S45 of the second lens L42, f4₂ is an effective focal length of the second lens L42, R4₃₁ is a radius of curvature of the object side surface S46 of the third lens L43, R4₃₂ is a radius of curvature of the image side surface S47 of the third lens L43, f4₃ is an effective focal length of the third lens L43, and f4₄ is an effective focal length of the fourth lens L44.

By the above design of the lenses and stop ST4, the lens assembly 4 is provided with a shortened total lens length, an effective corrected aberration and an increased resolution.

In order to achieve the above purposes and effectively enhance the optical performance, the lens assembly 4 in accordance with the third embodiment of the invention is provided with the optical specifications shown in Table 5, which include the effective focal length, F-number, field of view, total lens length, radius of curvature of each lens surface, thickness between adjacent surface, refractive index of each lens and Abbe number of each lens. Table 5 shows that the effective focal length is equal to 2.555 mm, F-number is equal to 2.0, field of view is equal to 82.0° and total lens length is equal to 3.500 mm for the lens assembly 4 of the third embodiment of the invention.

TABLE 5
Effective Focal Length = 2.555 mm F-number = 2.0
Field of View = 82.0° Total Lens Length = 3.500 mm

| | Radius of | | | | |
|---|---|---|---|---|---|
| Surface | Curvature | Thickness | | | |
| Number | (mm) | (mm) | Nd | Vd | Remark |
| S41 | 1.6796 | 0.3405 | 1.544 | 56.1 | The First Lens L41 |
| S42 | −4.1385 | 0.0200 | | | |
| S43 | ∞ | 0.0199 | | | Stop ST4 |
| S44 | 2.8044 | 0.2000 | 1.636 | 23.9 | The Second Lens L42 |
| S45 | 1.1158 | 0.2821 | | | |
| S46 | 6.1565 | 0.3205 | 1.544 | 56.1 | The Third Lens L43 |
| S47 | −7.4985 | 0.4450 | | | |
| S48 | −2.8115 | 0.4753 | 1.544 | 56.1 | The Fourth Lens L44 |
| S49 | −0.7672 | 0.2695 | | | |
| S410 | 24.9216 | 0.2970 | 1.582 | 30.2 | The Fifth Lens L45 |
| S411 | 0.8717 | 0.3985 | | | |
| S412 | ∞ | 0.1750 | 1.517 | 64.2 | Optical Filter OF4 |
| S413 | ∞ | 0.2566 | | | |

The aspheric surface sag z of each lens in table 5 can be calculated by the following formula:

z=ch²/{1+[1−(k+1)c²h²]^{1/2}}+Ah⁴+Bn⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F and G are aspheric coefficients.

In the third embodiment, the conic constant k and the aspheric coefficients A, B, C, D, E, F, G of each surface are shown in Table 6.

TABLE 6

| Surface | | | | | | | | |
|---|---|---|---|---|---|---|---|---|
| Number | k | A | B | C | D | E | F | G |
| S41 | −5.4255E−01 | −2.1033E−02 | −7.9912E−02 | 2.1524E−01 | −5.0824E−02 | −1.0410E+00 | 6.5694E−01 | 4.0672E−01 |
| S42 | −1.3044E+01 | 1.1591E−01 | 5.3020E−02 | −5.7690E−01 | 2.6129E−01 | 0.0000E+00 | 0.0000E+00 | 0.0000E+00 |
| S44 | −7.3607E+01 | 2.5467E−02 | 6.1200E−01 | −2.1788E+00 | 2.0538E+00 | −2.6718E−01 | 0.0000E+00 | 0.0000E+00 |
| S45 | −7.0628E+00 | 3.3995E−02 | 5.0809E−01 | −1.2817E+00 | 5.0965E−01 | 1.5230E+00 | −2.0862E+00 | 7.2356E−01 |
| S46 | −7.0494E+01 | −1.5050E−01 | 1.3562E−01 | −5.8089E−02 | 2.3831E−01 | 5.3146E−01 | −5.0504E−01 | −7.8466E−02 |
| S47 | 2.3069E+01 | −1.3394E−01 | 9.3223E−03 | −1.6912E−01 | 1.9707E−01 | 3.8709E−01 | −4.8903E−01 | 5.5613E−01 |
| S48 | 0.0000E+00 | 4.7480E−03 | −4.9994E−03 | 6.9145E−02 | −1.4701E−01 | −4.8372E−03 | 6.8039E−02 | −1.3239E−02 |
| S49 | −3.7978E+00 | −1.7158E−01 | 2.9052E−01 | −1.5408E−01 | 5.1273E−03 | 2.1992E−02 | −1.8385E−03 | −2.9307E−03 |
| S410 | 9.0000E+01 | −1.3109E−01 | 3.3520E−02 | 3.0882E−03 | −1.2914E−03 | −6.1803E−05 | 6.4100E−05 | −1.8627E−05 |
| S411 | −6.1992E+00 | −1.1826E−01 | 4.9462E−02 | −1.7089E−02 | 2.7101E−03 | −1.3841E−04 | −3.7874E−06 | 5.8200E−07 |

For the lens assembly 4 of the third embodiment, the Abbe number of the first lens L41 and the third lens L43 are equal to 56.1, the Abbe number of the fifth lens L45 is equal to 30.2, the Abbe number of the second lens L42 is equal to 23.9, the effective focal length f4 of the lens assembly 4 is equal to 2.555 mm, the distance TTL4 from the object side surface S41 of the first lens L41 to the image plane IMA4 along the optical axis OA4 is equal to 3.500 mm, the radius of curvature R4₁₁ of the object side surface S41 of the first lens L41 is equal to 1.67958 mm, the radius of curvature R4₁₂ of the image side surface S42 of the first lens L41 is equal to 4.13849 mm, the radius of curvature R4₂₁ of the object side surface S44 of the second lens L42 is equal to 2.80443 mm, the radius of curvature R4₂₂ of the image side surface S45 of the second lens L42 is equal to 1.11582 mm, the effective focal length f4₂ of the second lens L42 is equal to 3.03488 mm, the radius of curvature R4₃₁ of the object side surface S46 of the third lens L43 is equal to 6.15654 mm, the radius of curvature R4₃₂ of the image side surface S47 of the third lens L43 is equal to 7.49855 mm, the effective focal length f4₃ of the third lens L43 is equal to 6.24439 mm, and the effective focal length f4₄ of the fourth lens L44 is equal to 1.78600 mm. According to the above data, the following values can be obtained:

f4/TTL4=0.7300,

(R4₁₁−R4₁₂)/(R4₁₁+R4₁₂)=−2.3661,

(R4₂₁−R4₂₂)/(R4₂₁+R4₂₂)=0.4307,

f4₂/f4=−1.1878,

(R4₃₁−R4₃₂)/(R4₃₁+R4₃₂)=−1.1751,

f4₃/f4=2.4440,

f4₄/f4=0.6990
which respectively satisfy the above conditions (15)-(21).

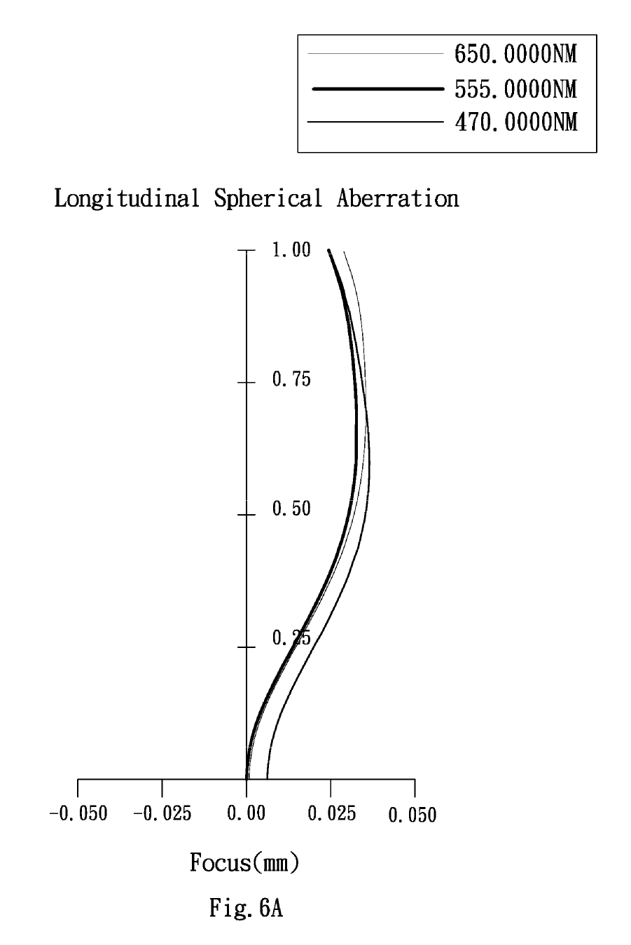

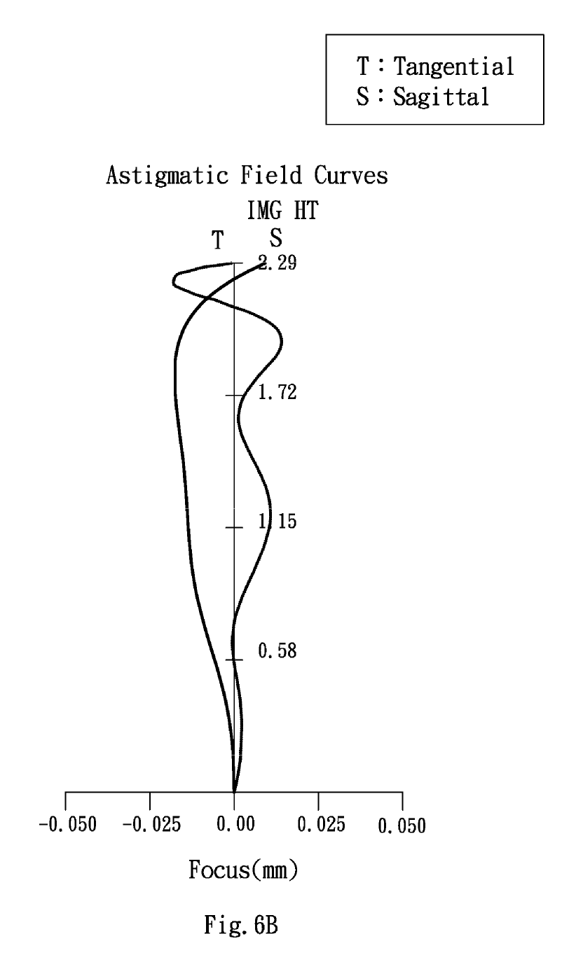

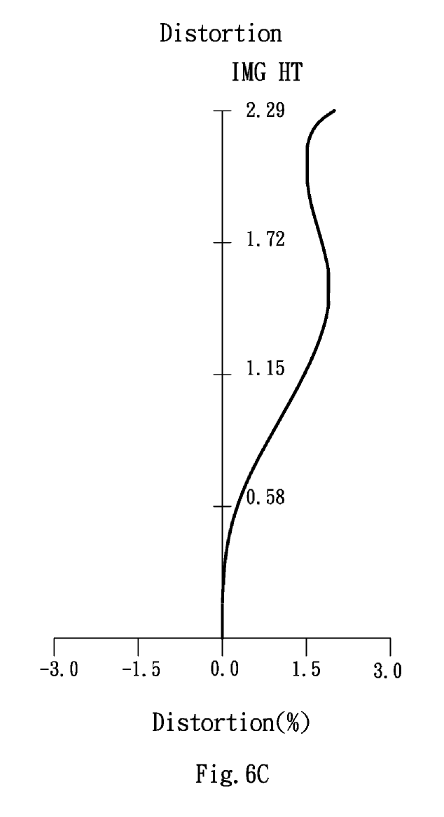

By the above arrangements of the lenses and stop ST4, the lens assembly 4 of the third embodiment can meet the requirements of optical performance as seen in FIGS. 6A-6C, wherein FIG. 6A shows a longitudinal spherical aberration diagram of the lens assembly 4 in accordance with the third embodiment of the invention, FIG. 6B shows an astigmatic field curves of the lens assembly 4 in accordance with the third embodiment of the invention and FIG. 6C shows a distortion diagram of the lens assembly 4 in accordance with the third embodiment of the invention.

It can be seen from FIG. 6A that the longitudinal spherical aberration in the lens assembly 4 of the third embodiment ranges between 0.000 mm and 0.040 mm for the wavelength of 470.0000 nm, 555.0000 nm and 650.0000 nm. It can be seen from FIG. 6B that the astigmatic field curves of tangential direction and sagittal direction in the lens assembly 4 of the third embodiment ranges between 0.025 mm and 0.025 mm for the wavelength of 555.0000 nm. It can be seen from FIG. 6C that the distortion in the lens assembly 4 of the third embodiment ranges between 0% and 2.5% for the wavelength of 555.0000 nm. It is obvious that the longitudinal spherical aberration, the astigmatic field curves and the distortion of the lens assembly 4 of the third embodiment can be corrected effectively. Therefore, the lens assembly 4 of the third embodiment is capable of good optical performance.

In the above first, second and third embodiments, both of the object side surface and image side surface of the first, second, third, fourth and fifth lens are aspheric surfaces. However, it has the same effect and falls into the scope of the invention that any of the object side surfaces or image side surfaces of the first, second, third, fourth and fifth lens are changed into spherical surfaces.

What is claimed is:

1. A lens assembly comprising a first lens, a second lens, a third lens, a fourth lens and a fifth lens, all of which are arranged in sequence from an object side to an image side along an optical axis, wherein:
the first lens is with positive refractive power;
the second lens is with negative refractive power;
the third lens is with positive refractive power;
the fourth lens is a meniscus lens and comprises a concave surface facing the object side and a convex surface facing the image side;
the fifth lens comprises a concave surface facing the image side;
the first lens and the third lens are made of the same material and an Abbe number of the first lens is the same as an Abbe number of the third lens;
an Abbe number of the first lens, an Abbe number of the third lens and an Abbe number of the fifth lens are greater than an Abbe number of the second lens; and
the fourth lens satisfies:
0.66≦f₄/f≦0.7
wherein f is an effective focal length of the lens assembly and f₄ is an effective focal length of the fourth lens.

2. The lens assembly as claimed in claim 1, wherein:
an Abbe number of the first lens, an Abbe number of the third lens and an Abbe number of the fifth lens are greater than an Abbe number of the second lens and an Abbe number of the fourth lens.

3. The lens assembly as claimed in claim 1, wherein the first lens, the second lens, the third lens, the fourth lens and the fifth lens are made of

4. The lens assembly as claimed in claim 1, further comprising a stop disposed between the object side and the second lens.

5. The lens assembly as claimed in claim 1, wherein:
the first lens comprises two surfaces, at least one of which is an aspheric surface or both of which are aspheric surfaces;
the second lens comprises two surfaces, at least one of which is an aspheric surface or both of which are aspheric surfaces;
the third lens comprises two surfaces, at least one of which is an aspheric surface or both of which are aspheric surfaces;
the fourth lens comprises two surfaces, at least one of which is an aspheric surface or both of which are aspheric surfaces; and
the fifth lens further comprises a surface, wherein the surface is an aspheric surface, or the concave surface of the fifth lens is an aspheric surface, or both of the surface and the concave surface of the fifth lens are aspheric surfaces.

6. The lens assembly as claimed in claim 1, wherein the first lens and the second lens satisfy:
−2.5≦(R₁₁−R₁₂)/(R₁₁+R₁₂)≦−1.9,
0.4≦(R₂₁−R₂₂)/(R₂₁ +R₂₂)≦0.5
wherein R₁₁ is a radius of curvature of an object side surface of the first lens, R₁₂ is a radius of curvature of an image side surface of the first lens, R₂₁ is a radius of curvature of an object side surface of the second lens and R₂₂ is a radius of curvature of an image side surface of the second lens.

7. The lens assembly as claimed in claim 1, wherein the second lens and the third lens satisfy:
0.4≦(R₂₁−R₂₂)/(R₂₁+R₂₂)≦0.5,
−14.0≦(R₃₁−R₃₂)/(R₃₁+R₃₂)≦−2.4
wherein R₂₁ is a radius of curvature of an object side surface of the second lens, R₂₂ is a radius of curvature of an image side surface of the second lens, R₃₁ is a radius of curvature of an object side surface of the third lens and R₃₂ is a radius of curvature of an image side surface of the third lens.

8. The lens assembly as claimed in claim 1, wherein the first lens and the third lens satisfy:
2.5≦(R₁₁−R₁₂)/(R₁₁+R₁₂)≦−1.9,
−14.0≦(R₃₁−R₃₂)/(R₃₁+R₃₂)≦2.4
wherein R₁₁ is a radius of curvature of an object side surface of the first lens, R₁₂ is a radius of curvature of an image side surface of the first lens, R₃₁ is a radius of curvature of an object side surface of the third lens and R₃₂ is a radius of curvature of an image side surface of the third lens.

9. The lens assembly as claimed in claim 1, wherein the second lens and the third lens satisfy:
1.2≦f₂/f≦−1.0,
2.2≦f₃/f≦2.7
wherein f₂ is an effective focal length of the second lens, f is an effective focal length of the lens assembly and f₃ is an effective focal length of the third lens.

10. The lens assembly as claimed in claim 1, wherein the lens assembly satisfies:
0.73≦f/TTL≦0.80
wherein f is an effective focal length of the lens assembly and TTL is a distance from an object side surface of the first lens to an image plane along the optical axis.

11. The lens assembly as claimed in claim 10, wherein:
the first lens is a biconvex lens and comprises a convex surface facing the object side and a convex surface facing the image side;
the second lens is a meniscus lens and comprises a convex surface facing the object side and a concave surface facing the image side;
the third lens is a biconvex lens and comprises a convex surface facing the object side and a convex surface facing the image side;
the fourth lens is with positive refractive power; and
the fifth lens is with negative refractive power.

12. The lens assembly as claimed in claim 11, wherein the fifth lens further comprises a convex surface facing the object side.

13. The lens assembly as claimed in claim 11, wherein the fifth lens further comprises a concave surface facing the object side.

14. The lens assembly as claimed in claim 1, wherein the first lens satisfies:
2.5≦(R₁₁−R₁₂)/(R₁₁+R₁₂)≦−1.9,
wherein R₁₁ is a radius of curvature of the convex surface of the object side of the first lens and R₁₂ is a radius of curvature of the convex surface of the image side of the first lens.

15. The lens assembly as claimed in claim 1, wherein the second lens satisfies:
0.4≦(R₂₁−R₂₂)/(R₂₁+R₂₂)≦0.5,
wherein R₂₁ is a radius of curvature of the convex surface of the object side of the second lens and R₂₂ is a radius of curvature of the concave surface of the image side of the second lens.

16. The lens assembly as claimed in claim 1, wherein the second lens satisfies:
1.2≦f₂/f≦−1.0
wherein f₂ is an effective focal length of the second lens and f is an effective focal length of the lens assembly.

17. The lens assembly as claimed in claim 1, wherein the third lens satisfies:
−14.0≦(R₃₁−R₃₂)/(R₃₁+R₃₂)≦−2.4
wherein R₃₁ is a radius of curvature of the convex surface of the object side of the third lens and R₃₂ is a radius of curvature of the convex surface of the image side of the third lens.

18. The lens assembly as claimed in claim 1, wherein the third lens satisfies:
2.2≦f₃/f≦2.7
wherein f₃ is an effective focal length of the third lens and f is an effective focal length of the lens assembly.

19. The lens assembly as claimed in claim 1, wherein the first lens, the third lens and the fourth lens are made of glass material, and the second lens and the fifth lens are made of plastic material.
